(19) United States
(12) Patent Application Publication
(10) Pub. No.: US 2002/0129239 A1
(43) Pub. Date: Sep. 12, 2002

(54) System for secure communication between domains

(76) Inventor: Paul C. Clark, Bethesda, MD (US)

Correspondence Address: CAHN & SAMUELS LLP, 2000 P STREET NW, SUITE 200, WASHINGTON, DC, 20036, US

(21) Appl. No.: 10/060,310

(22) Filed: Feb. 1, 2002

Related U.S. Application Data
(63) Continuation-in-part of application No. 09/568,215, filed on May 9, 2000.

(51) Int. Cl. H04L 9/00

(52) U.S. Cl. 713/153; 713/201

(57) ABSTRACT

A method of executing secure communications between first and second domains includes a translating data received from a node of the first domain to a target protocol and transmitting the translated data to a bastion host. The translated data may be filtered by the bastion host to block unauthorized transmissions. The data may then be authenticated and transmitted to a node of the second domain for use in an application. In one embodiment, the first domain is an untrusted domain and the second domain is a trusted domain.

This is a continuation-in-part of application Ser. No. 09/568,215, now pending.

### I. FIELD OF THE INVENTION

This invention relates to networks security. More particularly, this invention relates to systems and methods for securely transmitting data between both trusted and untrusted networks.

### II. BACKGROUND OF THE INVENTION

The Internet is rapidly changing the way business is conducted. Existing security mechanisms are deemed to be adequate for low value transactions, but are not sufficient for high value business-to-business (B2B) and Business-to-Consumer (B2C) transactions. Current solutions generally use Secure Socket Layer (SSL) to encrypt traffic between a client's browser and a web server. SSL provides confidentiality by encrypting session traffic at the network level, but does not provide authentication or non-repudiation of transactions. In addition, SSL protects traffic between the browser and the web server only. Many applications reside on a separate server, with the web server providing the front-end or user interface. Traffic between the web server and the application server is not protected by SSL. See FIG. 1. More particularly, known SSL systems employ 40 bit encryption with an option to upgrade to 128 bit encryption. Authentication is performed using standard password techniques. Batch transfer of large data files is not feasible.

FIG. 1 illustrates a conventional SSL system. As shown, an SSL web client 1 is connected to a web server 2 via an untrusted network, e.g., the Internet. Communication between the SSL web client 1 and the web server 2 is protected through encryption. Web server 2 also communicates with database server 3. A firewall 5 may be disposed between client 1 and web server 2 and between web server 2 and database server 3. However, no further security is associated with the communication.

Since web servers are often placed outside of the corporate firewall to allow open access to customers and partners, i.e., on untrusted networks, the web server is open to attack. There have been several documented attacks on web servers where customer information (i.e., credit card numbers) protected via SSL has been compromised. Further, although the data may be protected in transit, cases involving the defacement of web pages are too numerous to list.

Firewalls have been widely deployed on the Internet to protect corporate networks from outsiders. In order to allow access to customers and partners, services must be allowed through the firewall. Adding new services means adding new access holes in the firewall, and potentially adding new vulnerabilities. If an unauthorized user traverses the firewall, they may attack the web server with relative anonymity. Accordingly, there is a need for a system for securely communicating data between domains that protects the integrity of data in transit and data stored on a back-end server, e.g., web server, while allowing the appropriate level of access to authorized users.

### III. SUMMARY OF THE INVENTION

The system according to the present invention provides high assurance security services to network applications. The system can be placed in front of existing applications without modification to the original interface or back-end data processing. The system protects the mechanism used to intervene between the server and the client to dynamically protect user interface and data submission transactions. The invention is independent of the security services provided and the application protocol.

The invention exceeds the capabilities of SSL and eliminates the need for traditional firewalls. In one embodiment, a device may be disposed between client and the application server to perform an authentication check to identify the user and verify that the user is authorized to perform the requested function and that removes security features (de-enhances) from data originating from the client and bound for the server. If the user is not authorized to perform the function, then communication with the server may be restricted or blocked entirely.

In accordance with an aspect of the invention, a method for secure communication between first and second domains is provided. In the method a sender of an encrypted data transmission received from a logical unit is identified using a personal identifier associated with the data transmission. Upon identification of the sender, a determination is made as to whether the sender is authorized to perform the data transmission. If it is determined that the sender is authorized to perform the data transmission, the data is decrypted and sent to a logical unit in the second domain.

In accordance with another aspect of the invention, an article of manufacture comprising a computer usable medium having computer readable program code embodied therein for securely transmitting data from a trusted domain to an untrusted domain is provided. The article of manufacture includes computer readable program code for causing a first logical unit to identify a sender of an enhanced data transmission received from a second logical unit. The article of manufacture further includes computer readable program code for determining whether the sender is authorized to perform the data transmission. Computer readable program code is further provided for causing the first logical unit to de-enhance the data. Computer readable program code is also provided for causing the first logical unit to send the de-enhanced data to a third logical unit.

### IV. BRIEF DESCRIPTION OF THE DRAWINGS

FIG. 1 depicts a prior art SSL system.

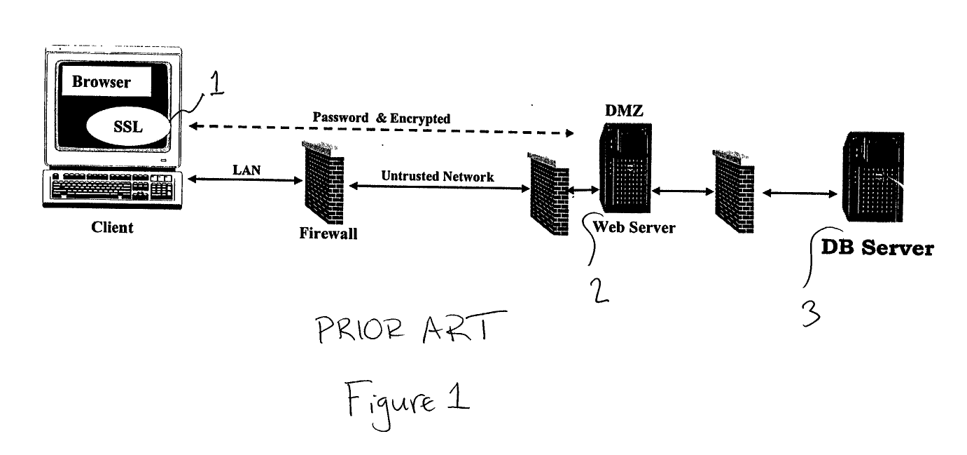

FIG. 2 depicts a secure communication system in accordance with the invention.

FIG. 3 is a flow chart showing data flow to and from the secure client.

FIG. 4 is a flow chart showing the data flow to and from the the cryptographic gateway.

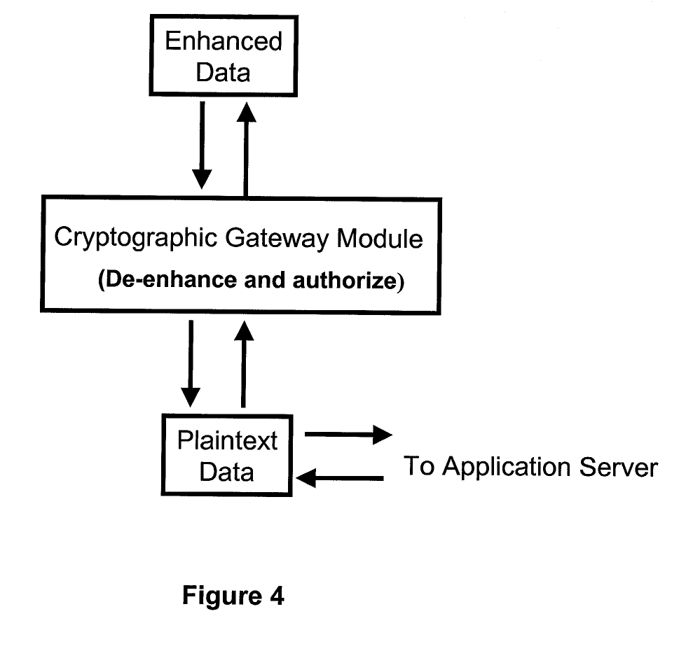

FIG. 5 is a block diagram of a standard PC.

### V. DEFINITIONS

The following definitions and explanations provide background information pertaining to the technical field of the present invention, and are intended to facilitate an understanding of the embodiments of the invention. Additional definitions and explanation may be provided throughout the disclosure.

Logical Unit—any device having data processing and transmission capabilities, e.g., computers, PDAs, smart cards, wireless phones and other intelligent devices. Logical units may be realized in circuitry, software or firmware that performs a particular function.

Domain—A domain is a single logical unit or a network of logical units.

Trusted Domain—a logical unit or network of logical units that is separated from other networks by a firewall or bastion host.

Untrusted Domain—a computer or network of computers that is publicly accessible.

Secure Client—logical unit that provides services to data before or after transmission to and from the server.

Bastion Host—A logical unit that separates administrative domains (e.g. firewall).

Cryptographic Gateway—a logical unit that provides server side security and authorization for data transactions.

Protocol Client—web browser, email package which would invoke security client, directly or indirectly.

ACL (Access Control List)—a list defining user groups and access rights for groups and individuals

Logical System—two or more cooperating logical units.

Data—A representation of facts, concepts, or instructions in a formalized manner suitable for communication, interpretation, or processing by human or automatic means, including but not limited to transactions, web forms, voice information, packets, datagrams, and messages.

### VI. DETAILED DESCRIPTION OF THE EMBODIMENTS

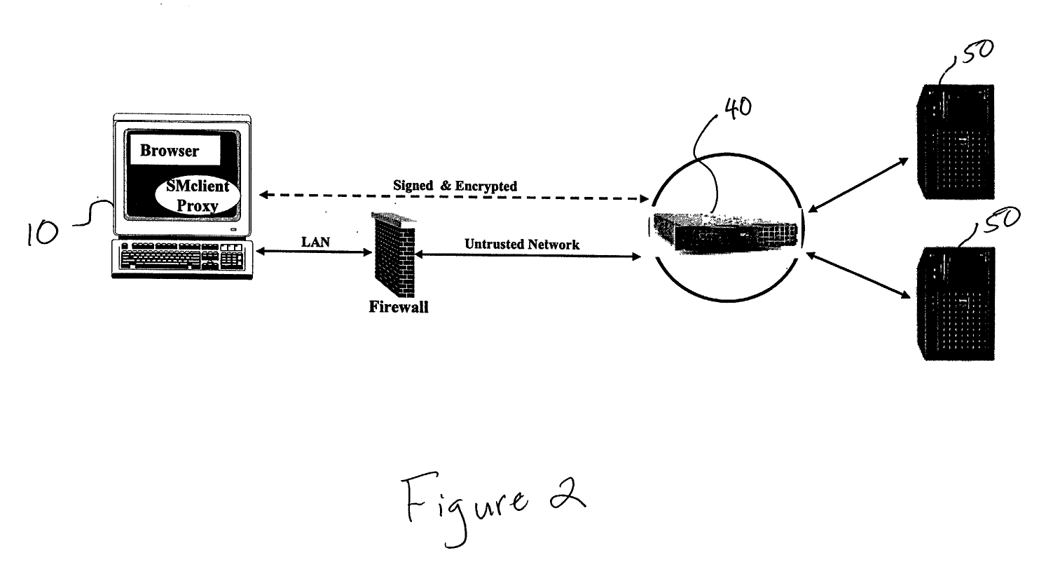

The present invention is directed to secure systems for communicating between domains. In accordance with a first embodiment, a system according to the invention may comprise at least two logical units including a client and a cryptographic gateway. As illustrated in FIG. 2, the system according to the present invention facilitates secure communication between domains, preferably untrusted and trusted domains. More particularly, secure communication between security client 10 and application server 50 via the cryptographic gateway 40 is enabled by the present invention. In preferred embodiments, security client 10 is preferably disposed in the first domain (typically an untrusted domain), cryptographic gateway 40 preferably defines a boundary between the first and second domains and application server 50 lies in the second domain (typically a trusted domain). As such, the security client 10 sends secured data across a first domain and through cryptographic gateway 40 to application server 50. When the data reaches the application server 50 it will be uncorrupted and it will be traceable to the sender. Responsive data may be returned to security client 10 in the reverse order.

Each logical unit as we have defined it is described in detail below.

Security Client

The security client 10 provides security services to data, otherwise referred to as enhancing data, before/after transmission to/from a server. The security client 10 can be deployed in software, hardware, and/or firmware. Preferably, security client 10 comprises a logical unit programmed or constructed to perform server side security and authorization services. Alternatively, security client 10 may be realized by computer readable program code embodied in a computer usable medium such as a CD ROM, a memory, a USB memory device, a SONY Memory Stick™, a disk, a smart card, a flash card, a carrier wave, or other computer usable medium. For example, security client 10 may be realized by software run on a workstation class machineor with a smartcard. Likewise a wireless PDA or cell phone might have the client loaded therein. The security client provides a combination of some or all of the following enhancement services: authentication, integrity, confidentiality and non-repudiation. These services are typically implemented but not limited to digital signature, key exchange, encryption, e.g., 3DES (2 or 3 key), biometrics, signature verification, and decryption. These services are provided in an algorithm and mechanism independent fashion. Any mechanism can be used as long as both security client 10 and the cryptographic gateway 40 support it. For example, authentication may be performed using the RSA, DSA, or elliptic curve algorithms. Optionally, a user might be identified with a biometric like a fingerprint, iris scan, retinal scan, voiceprint, etc. This feature allows the level of protection to be configured based on the sensitivity of the data transmitted. It is expected that new enhancement techniques will be developed in the future. Application of such techniques is contemplated by this invention.

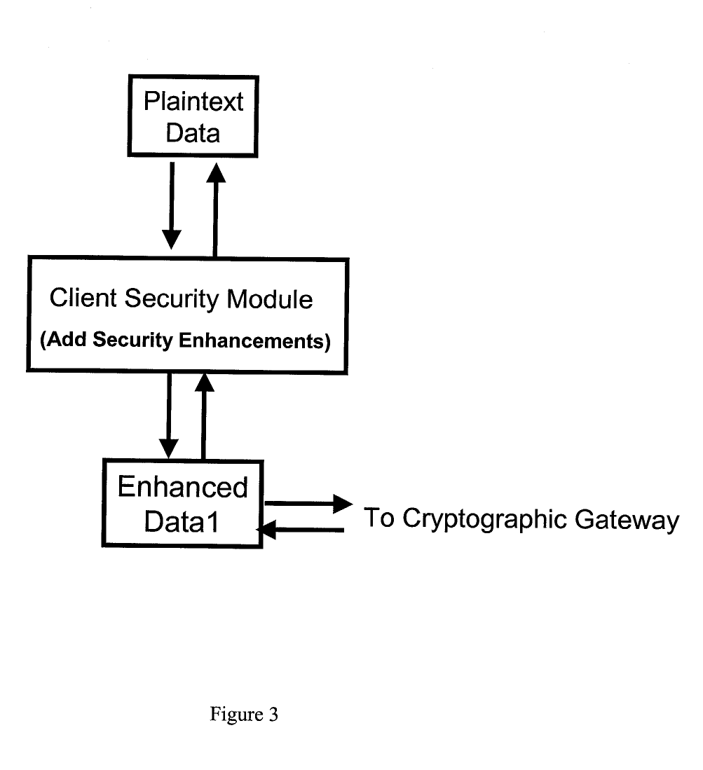

The security client 10 is preferably designed to interact with existing user interface applications and apply enhancement services in a manner known to those of skill in the art. As depicted in FIG. 3, plain text data and enhanced data may be applied to security client 10 where enhancement services (digital signature, encryption, biometrics, signature verification and data decryption) may be added and/or removed. The logical unit hosting security client 10 may run a plurality of client programs including but not limited to web browsers, email programs, file and database management programs, etc. For example, security client 10 may be implemented as a plug-in or proxy for Microsoft Internet Explorer®. When the browser receives data that has been signed and/or otherwise protected, it automatically starts security client 10. In addition, when a form contains certain hidden fields, the browser may be configured to pass the data through the security client to have encryption and/or signature protection added.

Cryptographic Gateway

Cryptographic gateway 40 provides the server side security and authorization services for data transactions. Preferably, cryptographic gateway 40 comprises a logical unit programmed or constructed to perform server side security and authorization services. Alternatively, cryptographic gateway 40 may be realized by computer readable program code embodied in a computer usable medium such as a DVD, a CD ROM, a disk, a smart card, a USB memory device, RAM, EEPROM, SONY Memory Stick™ a carrier wave, or other computer usable medium. Cryptographic gateway 40 performs de-enhancement services, e.g., signature verification and decryption services, as required on data received from security client 10. It also functions as a bastion host for all data transmitted by security client 10 and/or application server 50. Cryptographic gateway 40 also provides enhancement services, e.g., signs and/or encrypts, for data received from application server 50 before it is transmitted to the client. As shown in FIG. 2, the cryptographic gateway 40 is logically located between first and second domains, preferably between untrusted and trusted domains. This configuration enables data protection from the client's desktop to the application server. The cryptographic gateway 40 may be run on standard computer hardware, e.g., a workstation class machine or a PC. Alternatively, the cryptographic gateway may be embodied in add-in boards or a smart token.

Similar to security client 10, when cryptographic gateway 40 receives data from application server 50, it provides some combination of the following enhancement/de-enhancement services: data encryption, digital signature, decryption, and signature and/or biometric verification. The services are algorithm independent; however, to enable them to interact, it is preferred that the security client and the cryptographic gateway mechanisms and algorithms be compatible.

Cryptographic gateway 40 further performs an operation authorization function. That is, cryptographic gateway 40 performs an authentication check on data to determine whether the user is authorized to perform the requested operation. To facilitate authentication checking, cryptographic gateway 40 preferably has stored therein an access control list. Authentication checking is preferably performed by comparing information contained in the data received with information stored in the access control list.

Application Server

Application server 50 is logical unit that is preferably independent of the rest of the security system. Application server 50 provides a user interface and functionality to the system. The user interface may be transferred to security client 10 either statically or dynamically. For simple user interfaces that do not change very often, the user interface may be transferred to security client 10, embedded with the security features provided by the security system, and stored on security client 10 for later use. For complex or dynamically generated user interfaces, security client 10 can request the interface from application server 50 as needed. Security client 10 then adds the necessary security tags (if any).

When the client submits data to application server 50, the data may be signed and/or encrypted. Cryptographic gateway 40 verifies the signature and decrypts the data, then submits the data to application server 50. Application server 50 accepts the data the same way it would if connected directly to the client. Application server 50 may be completely unaware of the security services provided. After processing the data, application server 50 may send a response to security client 10. Cryptographic gateway 40 intercepts the response and provides any required enhancement security services. The secured data is then sent to the client.

Operational Aspects

In operation, a user desirous of making a secure connection to the application server 50 may initiate a connection with the cryptographic gateway 40. For example, the user may employ a web browser to access application server 50's web interface. When the user submits data to cryptographic gateway 40, security client 10 may enhance the data by providing encryption and/or digital signature services to the data as required. In certain applications, the security client need not provide enhancement services. If the data is encrypted, it may be transmitted across the first domain to the cryptographic gateway with minimal possibilities for corruption. That is, the data will be protected from the user's browser through the cryptographic gateway 40 to application server 50's domain.

The cryptographic gateway 40 preferably de-enhances the data by, e.g., verifying digital signatures and decryption. If the enhancement services are successfully removed, the data is preferably authenticated and authorized by, for example, checking the user's access rights against an access control list 55. If the user is authorized to perform the operation requested, the necessary data may be passed to application server 50 for further processing. If the user is not authorized to perform the operation, then the data is preferably blocked from passage to the application server 50. Responsive to a determination that the user is not authorized to perform the operation requested, optionally, the cryptographic gateway may send a message to application server 50 indicating that an unauthorized user has attempted to perform an operation on the application server. Optionally, a message may be sent to the client, e.g., indicating that the user does not have permission to access the application server.

When application server 50 finishes processing the data, it preferably sends response data to cryptographic gateway 40. The data may then be optionally protected via digital signature and/or encryption. The protected data is transmitted across the untrusted domain to security client 10. Security client 10 verifies any digital signatures and performs any required decryption. If these operations are successful, the data may be returned to the user, in the exemplary case to the browser where it may be displayed.

More particularly, as illustrated in FIG. 2A, security client 10 is preferably configured to accommodate a plurality of security clients 10. Each security client 10 may support one or more protocols, e.g., HTTP, SMTP, FTP, etc., preferably corresponding to a single outbound proxy. However, in alternate embodiments, the security client 10 may include more than one outgoing proxy. Data is enhanced by security client 10 and passed via the outbound proxy or proxies to cryptographic gateway 40. Cryptographic gateway 40 preferably includes at least a sufficient number of proxies to correspond to the outbound proxies of each security client 10, thereby enabling cryptographic gateway 40 to recognize data transmitted from each security client 10. Accordingly, when cryptographic gateway 40 recognizes the outbound proxy and recognizes the identity of the sender, i.e., authenticates the transmission, cryptographic gateway 40 removes enhancements from the data and passes the data on to application server 50. If cryptographic gateway 40 does not recognize the outbound proxy, the data is blocked from passing through cryptographic gateway 40 and, thus, prevented from reaching application server 50.

Likewise, application server 50 may transmit data securely through cryptographic gateway 40 to security client 10. Cryptographic gateway 40 enhances data received from application server 50 and passes the enhanced data to security client 10 using the outbound proxy corresponding to the destination security client 10. Data enhancements may then be removed by security client 10 and the data is available for use.

Operational Example

The systems and methods described herein may be employed to protect web applications from unauthorized access. In a typical web-hosting environment, the web application is placed outside of the firewall or on a DMZ in order to allow access. However, such placement leaves the web application vulnerable to attacks. The present invention provides access to web applications but restricts access to vulnerable data.

In keeping with the invention, the general flow of information for an exemplary web-enabled secure database (or other) application is as follows:

Web forms are either periodically refreshed to the security client 10 from application server 50, or dynamically retrieved from application server 50 by security client 10.

Web forms are may then be presented to the user in a Web browser.

The user may fill out the form and submit it to application server 50.

Prior to submission, security client 10 processes the data in the Web form, enhances the data (e.g. signs and/or encrypts it), as required from the local configuration and possibly the remote configuration from the cryptographic gateway, optionally informs the user of the enhancement in a client browser window, and transmits the enhanced message to cryptographic gateway 40.

Cryptographic gateway 40 de-enhances the data, checks the user's authorization to perform the desired actions, and transmits the data to application server 50.

Application server 50 produces a response either upon receipt of the data from cryptographic gateway 40 or responsive to a process checking for files received via ftp. Application server 50 checks that the data came from cryptographic gateway 40, may do an additional application-specific authorization check, processes the request, and returns the result to cryptographic gateway 40.

A process on the cryptographic gateway processes the result, possibly adding formatting, header information, etc., enhances the message and sends it to the security client 10.

The return of the enhanced result to the client Web browser invokes the security client, which de-enhances the result, informs the user in a client browser window, and presents the result to the user in the Web browser.

APP Section

Certain application-specific information will be completely ignored by cryptographic gateway 40 while security client 10 could potentially add to this information. The format of the <tag>=<value>pairs in this section should support application-specific authorization checking, all functionality available in Web forms, and maybe some additional features, such as images or other encoded binary data.

The <value>fields in this section will be encoded to support special characters, images and other binary data without the need for attachments and special processing.

A note on timestamps and hashing on the protocol gateway: Since no process is run on the cryptographic gateway right before the empty form is retrieved by the client, timestamps and hashes may be calculated by a (cron-like) process on the cryptographic gateway on a continuous basis—e.g., once a minute. Since the value of the hash and the hashing algorithm are part of the form to be hashed, the following procedure or similar could be followed on the cryptographic gateway when creating the timestamp and hash:

Lock the form file

open the form file

calculate timestamp and write it to gatewaytime, i.e. protocol gatewaytime=<timestamp>

blank out the value of the previous hash, i.e. hash=<blank>

write the hash algorithm to be used for the current hash, i.e. hash_algorithm=<algorithm to be used now>

close the form file

calculate the hash using the chosen algorithm

open the form file

write the new hash into the form file

close the form file

unlock the form file

On application server 50, information from the cryptographic gateway 40 can be received via multiple protocols: e.g. HTTP, SMTP, ftp or local. Depending on which protocol is used, the application process will be started differently.

Format of Resource Values In The Protocol and ACL Files

The value for the “resource” tag in the ACL file and the cryptographic gateway section of the client/server protocol is in URL format and contains information about the specific resource that the user is trying to access. Each resource URL begins with the protocol used, for example, ‘SM’ indicating applicant's protocol. However, any protocol is suitable for this invention. There are many different types of resources used in the authorization check on cryptographic gateway 40. In addition, there may be more detailed, application-specific resources, for which authorization can be checked on the application server 50 (for example, specific records in a database or subtasks/queries within an application). These are the resources for which authorization will be checked on cryptographic gateway 40:

Files and directories

securemethods://<network resource>/path/<filename>or <directoryname>

Applications

secremethods://<network resource>/path/<application name>

Network resources such as hosts, printers, mass storage devices, etc. securemethods://<network resource>/

Databases

securemethods://<network resource>/<database>

Database tables

securemethods://<network resource>/<database>.<database table>

Format of Access Control List File

An Access Control List (ACL) is preferably stored in a file on cryptographic gateway 40 and controls access to the various applications. This ACL file defines groups of users and access rights to resources both by these groups and by individual users.

The group and access rights sections are each started by a keyword (—GROUPS—and —ACL—). The resources to be accessed are listed one resource per line. Following the resource, the ACL file specifies the groups and individuals with access to the resource along with optionally the access rights for each group or individual. Access rights can be enclosed in parentheses and may consist of any or all of the following:

r—the individual or group can read the resource

a—the individual or group can append data to the resource

d—the individual or group can delete data from the resource

As shown in the example ACL file below, the ACL file preferably includes two sections—a group definition section, denoted by the—GROUPS—keyword, and a resource access section, denoted by the—ACL—keyword. In the example below, three groups are defined in the groups section: group1, group2, and group3. The ACL section defines access rights by these groups and several individuals to six resources: one directory, three files, one executable, and one database table.

# this is the group section
--GROUPS--
# administrator group
group1: jon, bob
# user group
group2: sue, josh
group3: sue, frank
--ACL--
securemethods://blah1.tcntr.com/: group1 (r)
securemethods://blah1.tcntr.com/file2: bob (r), jon (rad),

group2 (ra)

securemethods://blah2.tcntr.com/file2: group1 (ra), sue

(r), group3 (ra)

securemethods://blah1.tcntr.com/app1.exe: jon (rad), group1

(ra)

securemethods://blah1.tcntr.com/path/file1: group1 (r)
securemethods://blah2.tcntr.com/appdb.users: bob (rad),

joe (rad)

For readability, the resources could be grouped by the application they apply to or some other grouping, but this is optional Order should not matter when checking authorizations.

Maintaining ACL Files

Security Administrators can modify access to resources, including adding or removing users. A suitable tool for adding and removing users is the acledit program. The first argument to the acledit program indicates the type of modification being made; subsequent arguments provide additional information as appropriate for the action. This program supports the following types of ACL file updates:

1) Add a new resource

acledit 1 resource

where resource is in the format described above.

2) Add an individual's or a group's access to an existing resource

acledit 2 resource alias rights

where alias is the individual or group ID and rights are specified as described above

3) Add anew group

acledit 3 group-name

4) Add an individual to an existing group

acledit 4 group-name user-name

5) Delete a resource

acledit 5 resource

6) Delete a group

acledit 6 group-name

7) Delete an individual's or group's access to a resource

acledit 7 resource alias

8) Delete an individual from a group

acledit 8 group-name user-name

9) Replace an individual's or group's existing access to a resource

acledit 9 resource alias rights

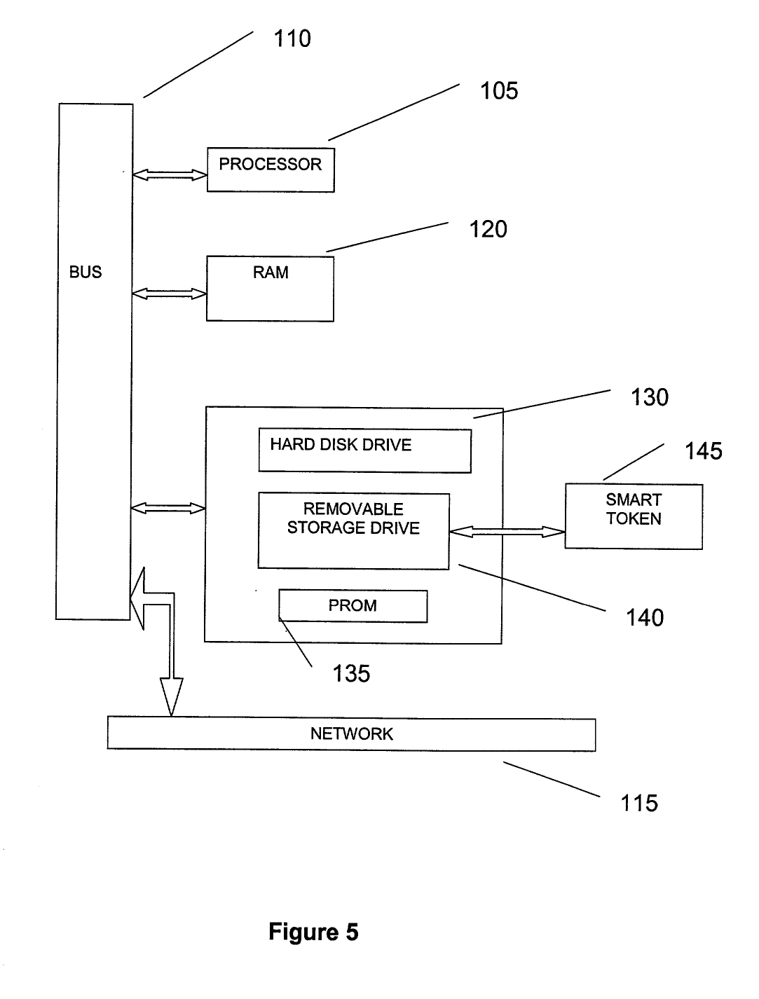

There are several advantages to the secure system of the present invention. The system can employ any type of digital signature, encryption algorithm or other security service. Each of the security client 10, the cryptographic gateway 40 and the application server 50 may reside on its own machine or physical platform, for example, a workstation class machine such as that depicted in FIG. 5. As shown, an exemplary work station class machine includes a processor 105, RAM 120, and memory unit all connected to bus 110. The memory unit may be at least one of hard disk drive 130, PROM 135, removable storage drive 140. The machine may also include smart token or token reader 145. Alternatively, neighboring components can be combined on a physical platform. For example, the cryptographic gateway and the application server could reside on the same physical platform, e.g., a standard PC. The system is also protocol independent and algorithm/mechanism independent. Any network service can be protected by the system described.

Additional advantages are provided by intervening in the client/server connection in the manner described herein. The invention facilitates seamless provision of the security services necessary for high-value electronic commerce without modification to existing applications. In keeping with the invention, the application server resides on a trusted domain and receives data from the untrusted domain only from the cryptographic gateway. The application user interface can be retrieved dynamically from the application server and/or cryptographic gateway. By dynamically retrieving the user interface from the protected application server when requested by the client, the user interface may be protected from modification.

In addition, by employing few logical units, the present invention facilitates fast, efficient processing of data transactions. The present invention is also fully scalable for any size enterprise.

It is to be understood that the embodiments described herein are merely exemplary of the principles of the invention and that, given the foregoing disclosure, the skilled artisan may make many variations and modifications without departing from the spirit and scope of the invention. All such variations and modifications are intended to be included within the scope of the invention as defined in the appended claims.

We claim:

1. A method for secure communication between first and second domains comprising:
identifying a sender of an encrypted data transmission received from a logical unit using a personal identifier associated with the data transmission;
determining whether the sender is authorized to perform the data transmission;
decrypting the data transmission if it is determined that the sender is authorized to perform the data transmission; and
transmitting the decrypted data to server

2. The method of claim 1 wherein the personal identifier is one of a biometric and a digital signature.

3. The method of claim 1 wherein determining whether the sender is authorized to perform the data transmission includes checking an access control list to determine the sender's privilege level.

4. The method of claim 1 further comprising preventing the data transmission from reaching the application server if it is determined that the sender is not authorized to perform the data transmission function.

5. The method of claim 1 further comprising enhancing data prior to sending the data transmission.

6. An article of manufacture comprising:
a computer usable medium having computer readable program code embodied therein for securely transmitting data from a trusted domain to an untrusted domain comprising:
first computer readable program code for causing a first logical unit to identify a sender of an enhanced data transmission received from a second logical unit;
computer readable program code for determining whether the sender is authorized to perform the data transmission; and
computer readable program code for causing the first logical unit to de-enhance the data; and
computer readable program code for causing the first logical unit to send the data to a third logical unit.

7. The article of manufacture of claim 6 wherein the data in the enhanced data is encrypted.

8. The article of manufacture of claim 6 wherein enhanced data includes biometrically secured data.

9. The article of manufacture of claim 6 further comprising computer readable program code for causing the first logical unit to determine a privilege level of the sender by searching an access control list that contains the sender's privilege level.

10. The article of manufacture of claim 6 further comprising program code for preventing the data from reaching the third logical unit if it is determined that the sender is not authorized to transmit the data.

11. A logical unit programmed to facilitate secure communication between first and second domains comprising:
a processor programmed to receive enhanced data transmitted from a first logical unit and to identify the sender of the enhanced data;
an access control list stored in a memory location including including access rights for the sender;
said processor further being programmed to query said access control list to determine whether the sender has sufficient rights to perform the data transmission, said processor being further programmed to de-enhance the data and to transmit the data to the second domain when it is determined that the sender has sufficient rights to perform data transmission.

12. A logical system for secure communication between first and second domains:
a first logical unit configured to enhance data and to transmit the enhanced data through an outbound proxy across the first secure domain; a second logical unit configured to receive data from said first logical unit, said second logical unit defining a boundary between the first domain and the second domain, said second logical unit being further configured to identify a sender of the enhanced data, to determine whether the sender has sufficient rights to perform the data transmission, said processor being further configured to de-enhance the data and to transmit the data to a logical unit in the second domain when it is determined that the sender has sufficient rights to perform data transmission.
